(19) United States
(12) Patent Application Publication
(10) Pub. No.: US 2003/0158765 A1
(43) Pub. Date: Aug. 21, 2003

(54) Method and apparatus for integrated network planning and business modeling

(76) Inventors: Alex Ngi, Ottawa (CA); Jeffrey Thomas Marcellus, Ottawa (CA); Stephen Beamish, Ottawa (CA)

Correspondence Address: TROPIC NETWORKS INC., DR. VICTORIA DONNELLY, 135 MICHAEL COWPLAND DRIVE, KANATA, ON, K2M 2E9, CA

(21) Appl. No.: 10/128,340

(22) Filed: Apr. 24, 2002

Related U.S. Application Data
(60) Provisional application No. 60/354,931, filed on Feb. 11, 2002.

(51) Int. Cl. G06F 17/60; G06F 15/173

(52) U.S. Cl. 705/7; 709/223

(57) ABSTRACT

The present invention provides an end-to-end network analysis tool that allows a network consultant to integrate link budget planning calculations with the network planning and business modeling phases of customer proposal generation. This integration provides for significantly reduced calculation times, more accurate business proposals, and the ability to model many different network scenarios. The benefits, savings, reduction in operational and capital costs and all the other elements of network savings relating to business parameters that are discovered may be summarized qualitatively and quantitatively in reports that may be presented to a customer company's senior management, in detailed or summary formats. This allows a network consultant to assist customers in migrating to a more profitable, efficient, effective and end-user driven network, while providing a customer with proof in the strength of their proposed solution and ability to deliver a low cost solution that maximizes the customer's return on investment.

### FIELD OF THE INVENTION

The present invention relates generally to the areas of communications networks and business case planning, and more specifically to the areas of optical network planning and business modeling, including cost calculation.

### BACKGROUND OF THE INVENTION

Communications networks are employed to distribute vast amounts of data to both corporate and individual entities in all walks of life. These communications networks are preferably interconnected so that data may be shared across the networks. An increase in the amount of data traffic being sent over such networks has resulted in a shift away from the use of lower capacity voice-centric networks to the use of higher-capacity data-centric networks, particularly those transmitting Internet Protocol (IP) data traffic.

The following definitions are provided for terms that will be used throughout this document:

The term network consultant will be used herein to represent an entity that provides network consulting services, such as network evaluation, network modeling and network estimation. In some cases, the network consultant may also be a provider of network equipment.

The term customer will be used herein to represent a customer of a network consultant. The term customer will therefore in most cases represent a service provider, such as an Internet service provider (ISP). A customer as defined herein may or may not own a network that is being used to provide such services.

The term end user will be used herein to represent the end user of a service that is provided by a customer, as defined above. Such an end user would be, for example, a user of a service provided by an Internet service provider.

For a customer that maintains and possibly owns communications networks over which services are provided, issues relating to network enhancement are of vital concern. (The term network enhancement will be used herein to represent any improvement, upgrade, maintenance, or change in design.) When a customer is in a position to consider network enhancement, the customer will often contact one or more network consultants in order to obtain quotations regarding the network design options that are available and the costs associated therewith.

In such a quotation process, a customer will typically provide estimated network demand statistics to the network consultant, who then performs sophisticated network demand calculations in order to determine the type of network that would best suit the carrier company's needs. These network demand calculations are usually performed using a series of complicated algorithms and, because of their complexity, may take up to a month to complete.

After completing these calculations, the network consultant then typically selects a network architecture to suit the customer's needs. This network architecture is generally optimized with respect to one or more customer requirements or parameters. Based on the determined network architecture, the network consultant may, in some cases, then complete another independent set of financial calculations in order to produce tangible outputs, such as a total cost of ownership for a proposed network enhancement. These financial calculations are typically performed manually on spreadsheets and may be outsourced to another company, if they are performed at all. A proposal, or business case, is then presented by the network consultant to the customer for their consideration.

However, some drawbacks exist with respect to such a conventional network planning process. A major drawback is that the network planning process and the financial calculation process are usually performed independently of each other, to a large extent. Therefore, changes in network planning considerations may not be immediately reflected in business modeling considerations, and vice versa. This may result in network designs or business proposals that are based on inaccurate or out-of-date information. Also, in the typical network planning process, the time delay between the first contact with the network consultant and the receipt of a completed business case can be prohibitively long. Therefore, if any or all of the steps in the process need to be repeated due to changes in network demand statistics, changes in a customer's financial situation, or any other factor, such updated calculations will require an additional amount of time, possibly equal to the time taken for the original calculations. These large time delays may discourage a customer from requesting such updated calculations, and may discourage a network consultant from performing the updated calculations. This may further compound the fact that network designs or business proposals may be based on inaccurate or out-of-date information.

In the event that a customer wants to make changes to a proposed network design “on the fly” during the network modeling phase, most conventional tools cannot easily handle or reflect such dynamic changes. In most circumstances, conventional network modeling tools are somewhat limited in their capabilities to the extent that the financial effects caused by such network design changes would not be known for some time.

Therefore, there is a need in industry for an improved system and method for optical network planning and business modeling.

### SUMMARY OF THE INVENTION

The present invention seeks to provide an improved network planning and network cost calculation process that overcomes or mitigates at least one of the drawbacks of the conventional processes.

In contrast with known systems and methods, embodiments of the present invention advantageously integrate link budget planning calculations with the network planning and business modeling phases of proposal generation. This, in turn, significantly reduces the time required to perform the necessary calculations and thus permits a network consultant to provide a customer with more accurate results in a timelier manner while at the same time identifying and delivering additional savings to the customer. Furthermore, embodiments of the present invention are able to deliver a tremendous amount of network information to a customer all at once prior to implementing a proposed network enhancement.

According to an aspect of the invention, there is provided a computer-implemented method for performing integrated optical network planning and business modeling, comprising the steps of: a) obtaining a network configuration based on customer parameters; b) performing link budget calculations based on said network configuration and customer parameters; c) generating an equipment list based on said link budget calculations; d) calculating, based on said equipment list, at least one business parameter associated with implementation of said network configuration; and e) storing or displaying data associated with such business parameter.

Preferably, the customer parameters include customer topology and standardized customer demand, with the latter preferably including aggregate customer demand by node and line side port count by node. The customer topology preferably includes an identification of nodes and physical links in the topology.

Advantageously, step a) in the method above includes determining the network configuration based on customer parameters. Preferably, the method includes, before step a), the steps of: receiving customer demand per node port from the customer; and converting the received customer demand into standardized customer demand. Step a) may also, for example, include the step of determining node and layer 1 logical link topology for the network configuration, and step b) preferably further includes the step of performing calculations based on such topology.

Preferably, between steps b) and c), the following steps are performed in order to iteratively arrive at an enhanced network configuration: producing a revised customer topology based on the network topology and the link budget calculations; and repeating steps a) and b) wherein the customer parameters comprise customer demand and the revised customer topology.

In the method above, the business parameter is advantageously a cost. Some examples of such cost include: capital cost, operational cost, cost to own, cost to grow, cost to build, net present value, total cost of operation, and time value of money.

According to a preferred embodiment of the present invention, the method as listed above further comprises the step of producing a report based on a business parameter. Such report may be a simple report such as, for example, a bill of materials, a listing of node configurations, and a raw data file. The step of producing a report may advantageously include generating, based on the stored or displayed data, an advanced network business report, such as: cost/benefit analysis, full risk analysis, return on assets, return on invested capital, capital expenditure, operational expenditure, net present value, total cost of operation, time value of money, total cost of ownership, cost to build, cost to own, cost to grow.

According to another aspect of the present invention, there is provided a system for integrated optical network planning and business modeling, comprising: network planning means for obtaining a network configuration based on customer parameters; link budget planning means for performing link budget calculations based on said network configuration and customer parameters, and for generating an equipment list based on said link budget calculations; and business modeling means for calculating a business parameter associated with implementation of said network configuration based on said equipment list, and for storing or displaying data associated with said business parameter.

According to a further aspect of the present invention, there is provided a computerized system for integrated optical network planning and business modeling, comprising: network planning means for obtaining a network configuration based on customer parameters; link budget planning means for performing link budget calculations based on said network configuration and customer parameters, and for generating an equipment list based on said link budget calculations; and business modeling means for calculating a business parameter associated with implementation of said network configuration based on said equipment list, and for storing or displaying data associated with said business parameter.

Preferably, the customer parameters include customer topology and standardized customer demand, with the latter preferably including aggregate customer demand by node and line side port count by node. The customer topology preferably includes an identification of nodes and physical links in the topology.

Advantageously, the network planning means of the computerized system includes means for determining the network configuration based on customer parameters, and the system preferably comprising bandwidth modeling means for receiving customer demand per node port from the customer; and for converting the received customer demand into standardized customer demand.

In the computerized system described above, the network configuration on which the link budget calculations are based advantageously includes node and layer 1 logical link topology. The link budget planning means in the computerized system described above preferably comprises: means for producing a revised customer topology based on the network topology and the link budget calculations; and means for transmitting the revised customer topology to the network planning means. These means may cooperate to iteratively arrive at an enhanced network configuration based on the revised customer topology.

In the computerized system above, the business parameter is advantageously a cost. Some examples of such cost include: capital cost, operational cost, cost to own, cost to grow, cost to build, net present value, total cost of operation, and time value of money.

According to a preferred embodiment of the present invention, the business modeling means in the computerized system as described above comprises means for producing a report based on a business parameter. Such report may be a simple report such as, for example, a bill of materials, a listing of node configurations, and a raw data file. The business modeling means may advantageously include an advanced report generating means for generating, based on the stored or displayed data, an advanced network business report, such as: cost/benefit analysis, full risk analysis, return on assets, return on invested capital, capital expenditure, operational expenditure, net present value, total cost of operation, time value of money, total cost of ownership, cost to build, cost to own, cost to grow.

According to a yet further aspect of the present invention, there is provided a computer program product comprising a computer-readable memory storing statements and instructions for use in the execution in a computer of a method according to an embodiment of the present invention.

According to a still further aspect of the present invention, there is provided a computer data signal embodied in a carrier wave and representing sequences of instructions which, when executed by a processor, cause the processor to calculate network costs in an automated manner by performing the steps of a method according to an embodiment of the present invention.

According to yet another aspect of the present invention, there is provided a link budget planning apparatus suitable for use in a system according to an embodiment of the present invention.

The present invention advantageously provides an end-to-end analysis tool that allows a network consultant to create custom specific models for each customer. Advantageously, in an embodiment of the present invention, the present invention comprises an interactive computer-implemented program that starts from the network planning phase all the way through to the end-application revenue enhancement phase. As such, embodiments of the present invention assist a customer in migrating to a more profitable, efficient, effective and end-user driven network.

In contrast to proposals generated by conventional processes and means, embodiments of the present invention allow a network consultant to provide a customer with proof in the strength of their evaluations, models, and/or product offerings and deliver a low cost solution that maximizes the customer's return on investment. This is advantageously provided by the fact that embodiments of the present invention permit a network consultant to accurately model existing customer networks, and also to compare such existing networks to competitors' networks and to proposed networks.

The benefits, savings, reduction in operational and capital costs and all the other elements of network savings that are preferably discovered according to embodiments of the present invention are advantageously summarized in qualitative and quantitative fashion in reports that may be presented to a customer company's senior management. An Executive Summary may be provided for all areas of a network analysis. For example, an Executive Summary may be presented for Network Architecture Costs, Cost to Build, Risk Analysis, Cost/Benefit Analysis and many other areas. Additionally, a detailed analysis and set of recommendations may be provided based on the calculated business parameters to help a customer understand all the advantages that the network consultant's solution brings to the customer.

Although the present invention is particularly applicable with respect to fully optical networks, the embodiments described herein also provide advantages for planning and business modeling of optical networks that contain at least one electrical or electronic network component.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Embodiments of the present invention will be further described with reference to the accompanying drawings, in which:

FIG. 1 illustrates a customer specific network model according to an embodiment of the present invention;

FIG. 2 illustrates another customer specific network model according to an embodiment of the present invention;

FIG. 3A illustrates node traffic characteristics for an example generic network according to an embodiment of the present invention;

FIG. 3B illustrates demand growth by year for an example generic network according to an embodiment of the present invention;

FIG. 4A illustrates a flow diagram representing a method and system according to an embodiment of the present invention;

FIG. 4B illustrates a flow diagram representing a method according to another embodiment of the present invention;

FIG. 5 illustrates a five-node linear network topology of a sample customer network;

FIG. 6 illustrates network demand parameters with respect to the network illustrated in FIG. 5;

FIG. 7 illustrates a network topology of another sample customer network;

FIG. 8 illustrates diagrammatically customer demand relating to the network of FIG. 7;

FIG. 9 illustrates a wavelength map of the customer demand shown in FIG. 6;

FIG. 10 illustrates the demand illustrated in FIG. 8 in terms of internal aggregated demands;

FIG. 11 illustrates the demands of FIG. 10 in terms of wavebands;

FIG. 12 illustrates an optical layer output relating to the network of FIG. 11;

FIG. 13 illustrates a sample equipment list relating to the network of FIG. 12;

FIG. 14 illustrates a graphical depiction of a demand growth curve upon which a cost to build business parameter is calculated according to an embodiment of the present invention; and

FIGS. 15, 16, 17A, 17B and 18 illustrate specific examples of advanced network business reports according to embodiments of the present invention.

### DETAILED DESCRIPTION OF THE INVENTION

### Network Modeling

Generic Network Model

According to an embodiment of the present invention, a generic network model is employed in order to determine a network configuration based on customer parameters. This network configuration is preferably optimal with respect to one or more customer parameters or requirements. In an apparatus according to an embodiment of the present invention, this determination of a network configuration using a generic network model may be performed at a network planning means. The generic network model that is employed characterizes a network on the basis of a plurality of input and output parameters across the network rather than on the basis of characteristics of specific network element models. This allows for the modeling of ring and mesh network topologies, as well as any other topology, since the generic network model is independent of the network topology. The generic network model provides a framework within which a network consultant can compare a proposed network enhancement to a customer's current network, a partner's specific network topology, or a competitor's proposed solution. These models may include traditional SONET (Synchronous Optical NETwork), NG-SONET (Next Generation SONET) and MSPP (Multi-Service Provisioning Platform) solutions. A network consultant employing this generic network model can thus demonstrate the efficiency and effectiveness of their proposed solution compared to other network solutions, whether existing or proposed.

The generic network model according to an embodiment of the present invention is preferably based on a customer generic topology. In a preferred embodiment, the customer generic topology is based on a generic IEEE topology. However, so long as a chosen generic topology accurately reflects a real customer topology, any suitable topology may be used.

Customer Specific Network Model

An advantage of an embodiment of the present invention is the ability to accurately model a customer's network to accurately identify and investigate the pressure points and areas of opportunity within the network. Such information may not have originally been provided or identified by the customer. Therefore, the network consultant, using such information, can provide a more thorough treatment of any proposed network enhancement. Using such a customer specific network model, it becomes possible to model customer network growth projections and to understand the challenges that the network will face, based on the details of where this growth will come from.

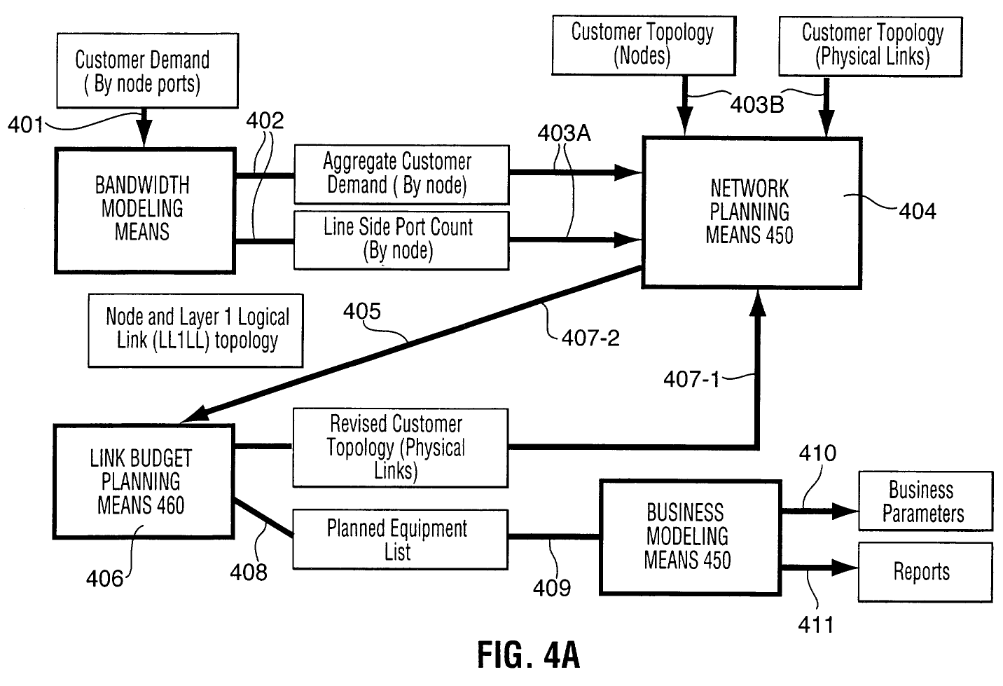

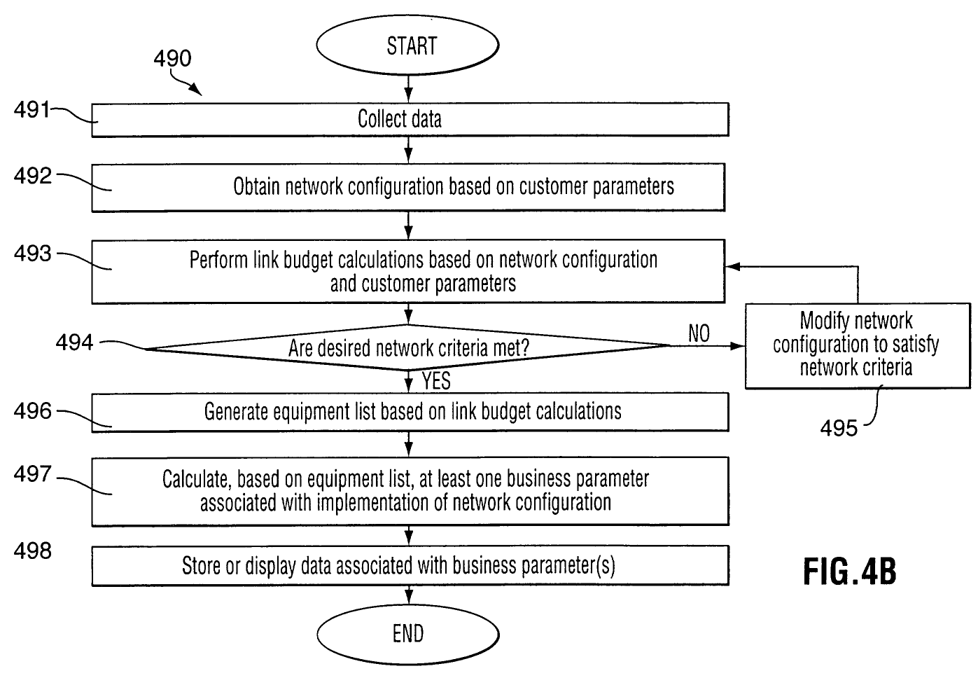

Using this customer specific network model, an appropriate network configuration may be determined, based on parameters supplied by the customer. The determination of a network configuration may be effected by the customer, or by the network consultant, or by a third party. The use of a customer specific network model allows for such determination to be made by any party, as long as the network consultant can obtain the network configuration in a proper format for use in accordance with a method or apparatus according to an embodiment of the present invention. This will be discussed further with reference to FIG. 4A.

In a preferred embodiment of the present invention, these customer parameters comprise customer demand and customer topology. Customer demand is a measure of the anticipated demand by end-users with respect to services that are provided by a customer. Such a customer demand parameter may be based on current measured end-user demand statistics, or may be based on forecasted end-user demand. This demand is preferably measured in terms of bandwidth, but may alternatively be measured with respect to classes of service, types of service, or any other measurement. Further details regarding customer demand parameter units of measure are discussed with reference to FIG. 4A.

An example of customer demand parameters for two sample customer networks is provided in Table 1 below.

TABLE 1

| | Customer Network #1 | Customer Network #2 |
|---|---|---|
| Network topology | 7 rings, 17 Nodes, | 5 rings, 37 Access Nodes, |
| | 4 Hub sites | 12 Hub sites Access nodes |
| | | provide groomed traffic |
| | | Only metro core is |
| | | modeled |
| Planning period | Years | 6 years |
| Traffic pattern | 46% SONET, | 100% Packet |
| (yr 1) | 54% Packet | |
| | 17 Gb/s avg termi- | 10 Gb/s avg termination |
| | nation per node | per node |
| | All demands are OC-3 | All demands are Mb/s over |
| | rates | GbE |
| | Traffic is non pre- | Some demands are |
| | emptible, and pt-pt | multiplexed |
| | Protection only on | Traffic is non pre- |
| | network interfaces | emptible, and pt-pt |
| | | Protection only on network |
| | | interfaces |
| Traffic growth | SONET @ 7.5% AGR | Packet @ 40% AGR |
| | Packet @ 40% AGR | Legacy Network Offload |
| | | of 20Gb/s/yr for 4 yr |
| | | Demand shifting (churn) |
| | | incorporated |
| Fiber | Optimize Fiber Use | Optimize fiber use |
| | No˜WDM used, no | WDM used, no amplifiers |
| | amplifiers | |

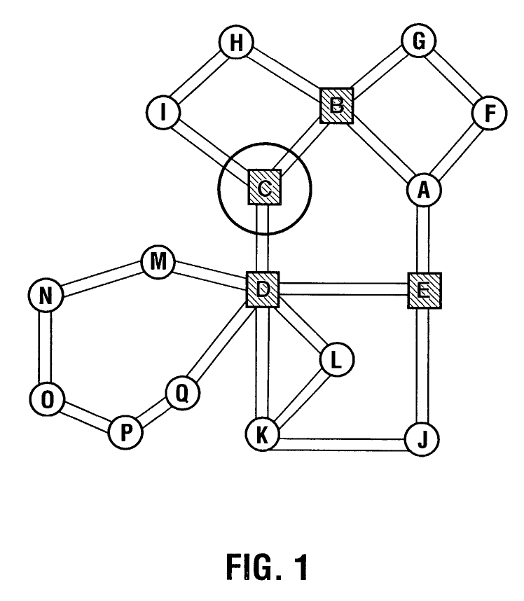

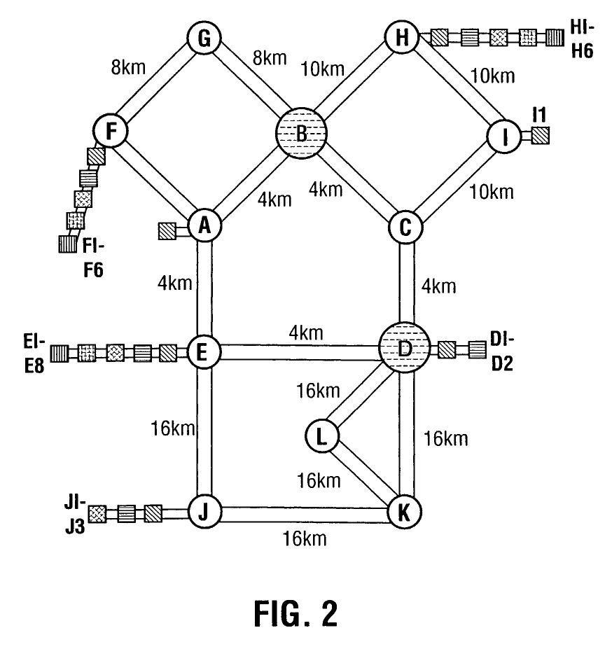

FIGS. 1 and 2 illustrate, respectively, representations of customer networks #1 and #2 using the generic network model described above. FIG. 2 is an adaptation of FIG. 1 to show a different view of the generic network topology. In the table above, Customer Network #1 was applied to FIG. 1, and Customer Network #2 was applied to FIG. 2, to show different final customer network designs.

With respect to sample customer network #1, the customer demand of 46% SONET traffic and 54% packet traffic is based on the assumption that the amount of data traffic carried by local exchange carriers (LECs) will be equal to that of voice traffic. The Annual Growth Rates (AGRs) used for sample customer network #1 are 7.5% for SONET traffic and 40.0% for packet traffic. The demand patterns for customer network #1 may be further partitioned as follows:

46% SONET (100% protected):

100% from Access to Long Haul Sites (nodes B and D);

54% Packet Traffic (50% protected, except where noted):

50% from Access to Long Haul sites (nodes B and D);

50% Local traffic;

50% Data Center traffic (to nodes C and E) (100% protected); and

50% Inter-Node traffic.

Protected traffic is defined as traffic having service guarantees, where route diversity is provided in order to counteract the effects of possible equipment or node or fiber failure. Unprotected traffic has no such arrangements in place, and therefore may experience loss of services in case of a failure.

Average node terminations in this example are 17 Gb/s in year 1 and 36 Gb/s in year 4. Long haul hubs in this example terminate nearly 120 Gb/s in year 4.

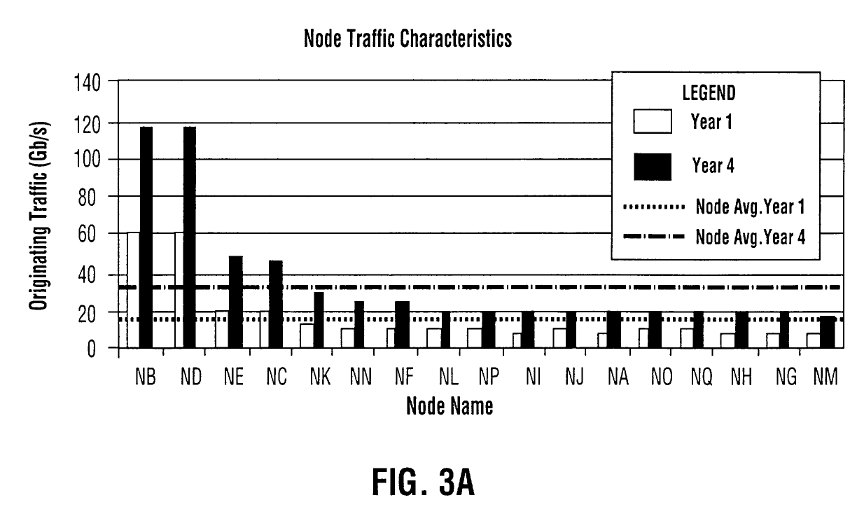

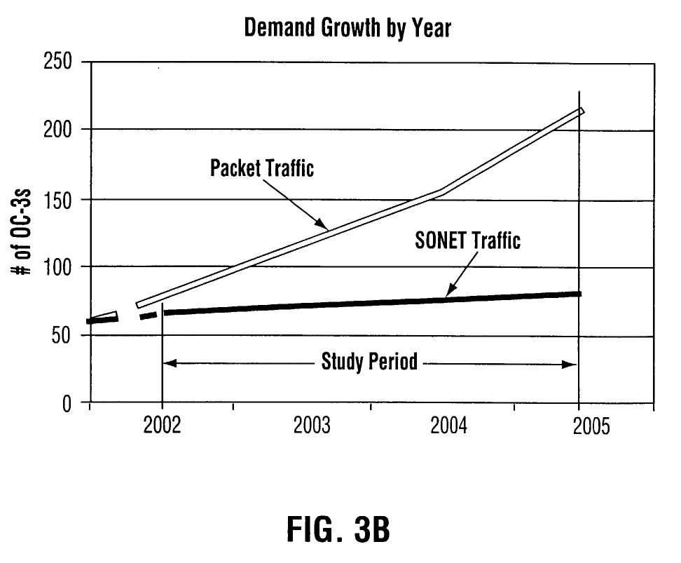

Node traffic characteristics for this example network are shown in FIG. 3A, whereas Demand growth by year is shown in FIG. 3B. FIG. 3A illustrates originating traffic (in Gb/s) for different nodes in sample customer network #1, each having a different node name. FIG. 3B illustrates the number of OC-3s required for such a network over a sample study period in light of the demand growth rates provided above.

FIG. 4A illustrates a flow diagram showing steps in a method according to an embodiment of the present invention. Also illustrated in FIG. 4A are various means that may be employed in an apparatus according to an embodiment of the present invention. In an embodiment of the present invention, optional steps 401 and 402 may be performed. These optional steps are performed in a case where a customer demand value received from a customer is not in a standardized format suitable for use by embodiments of the present invention. The term standardized customer demand is used herein to represent any format or unit of measurement of customer demand that may be used directly by embodiments of the present invention.

In step 401, a non-standardized customer demand parameter is received at bandwidth modeling means 440. This received customer demand may be defined, for example, with respect to node ports, or may be of any other format that is not used as a native format by embodiments of the present invention. In step 402, the bandwidth modeling means 440 converts this customer demand defined with respect to node ports into standardized customer demand. In this example, standardized customer demand comprises two separate customer demand parameters: aggregate customer demand by node, and line side port count by node. In such an embodiment of the present invention, this conversion is performed by bandwidth modeling means 440.

The network consultant may receive the non-standardized customer demand and use bandwidth modeling means 440 to perform the necessary conversion. In an alternate preferred embodiment where the bandwidth modeling means is not employed by the network consultant, the customer demand parameters of aggregate customer demand by node and line side port count by node may be provided directly from the customer to the network consultant. The customer, in such a case, is responsible for obtaining these demand parameters in standardized format, and may employ a bandwidth modeling means similar to the one described above, or may outsource the determination or obtaining of such parameters to a third party. In any case, so long as the customer demand parameters are provided in the standardized format for use in accordance with a method or apparatus according to an embodiment of the present invention, it is inconsequential whether the calculation and determination of customer demand parameters is performed by the network consultant, by the customer, or by a third party. It is sufficient that the network consultant is able to obtain the network configuration, and that this is preferably expressed in terms of standardized customer demand.

Regardless of how the customer demand parameters are obtained, in step 403A, these customer demand parameters are provided to a network planning means 450. In step 403B, customer topology parameters are also provided to the network planning means 450. In a preferred embodiment, the customer topology parameters comprise: customer topology with respect to nodes, and customer topology with respect to physical links.

The network planning means 450 is any means that is capable of receiving and processing the customer demand and customer topology parameters, and subsequently generating data in a proper format to be sent to a link budget planning means 460. In a preferred exemplary embodiment, the network planning means 450 employed is the VPItransportMaker™, available from VPIsystems™. Currently, VPItransportMaker™ is being offered as a bundle in VPIsystems' software product entitled VPIdesignCenter™, which integrates VPIcomponentMaker™, VPItransmissionMaker™ and VPItransportMaker™ in an efficient product design environment.

In step 404, the network planning means 450 determines a network configuration based on the provided customer parameters. This network configuration is preferably optimized with respect to one or more of such customer parameters. As mentioned above, in this embodiment the customer parameters comprise customer demand and customer topology. In step 405, the network configuration is sent from the network planning means 450 to the link budget planning means 460. In a preferred embodiment, this step comprises sending a node and layer 1 logical link (L1LL) topology of the network configuration. Although the network planning means 450 is capable of making numerous types of determinations and providing numerous types of output related to network planning, the network configuration is the output that is advantageously employed according to embodiments of the present invention. In an alternate embodiment, steps 401-404 are performed off-site (with respect to the network consultant), and step 405 comprises obtaining a network configuration based on the results of off-site steps 401-404.

In step 406, the link budget planning means 460 performs various link budget calculations based on the network configuration and the customer parameters. In step 408, the link budget planning means 460 produces an equipment list based on the link budget calculations. Link budget planning, as in step 406, is a process by which a set of routed wavelength demands are compared against a set of rules for deploying optical equipment based on optical attenuation, chromatic dispersion, non-linear effects and cost. In essence, the link budget planning means converts customer traffic demands into lightpaths and calculates the optics required to implement a suitable solution. In step 408, the results of the link budget planning step are presented as an equipment list, upon which financial calculations may be based. This equipment list preferably shows the configuration of the node, the position of all cards in a shelf and the internal and external fiber connections of a node.

In a preferred embodiment of the present invention, the link budget planning means and network planning means iteratively co-operate to optimize a proposed customer topology based on the link budget calculations from step 406. This process is preferably achieved in the following manner. In step 407-1 a revised customer topology, based on physical links, is sent to the network planning means 450 for redefinition of a network configuration based on the revised customer topology. Step 407-1 is indicative of the advantageous iterative nature of the closely coupled networking planning and link planning steps.

The circumstances surrounding the initiation of step 407-1 may be as follows. Suppose, for instance, that following the execution of the network planning steps, it is determined that traffic is to be routed along a particular route. Then, suppose that during execution of the link planning steps, it is determined that the wavelength needed to transport the traffic is very expensive or unfeasible with current equipment capabilities. In such a case, through step 407-1, the method would return to the network planning steps in order to select a different route and then repeat the link planning steps with the different route.

As a specific example, step 407-1 may itself comprise sending an optical topology to the network planning means 450 for redefinition of a network configuration based on the optical topology. In this case, the sending of an optical topology is simply one specific reason that the method may return to the network planning steps from the link planning steps—the reason that there is insufficient fiber capacity in the network and that it may be necessary to add physical links to the network. Of course, there are numerous situations in which the method would return to the network planning steps in order to optimize the process with respect to one or more desired criteria. Some other exemplary conditions under which a revised topology is sought include: fiber exhaustion; planned fiber capacity increases; low cost leased fiber capacity available from other carriers; fiber type upgrade; and recommendation from network planner for new fiber capacity.

In step 407-2, the network planning means 450 then uses the revised customer topology along with the originally provided customer demand to optimize the network configuration. This process of sending such revised topology/ies between the network planning means and the link budget planning means, i.e. steps 407-1 and 407-2, may be iteratively repeated until a desired result is achieved. The point at which such iteration will be stopped may be the point at which a particular parameter reaches a user-defined threshold. This threshold may be preferably defined by the customer, or alternatively by the network consultant. For instance, where all the demand requirements are satisfied and the cost model appears favorable to the customer, iterations may be stopped. Any other type of threshold, for instance comprising a specified set of desired values or tolerances, is suitable, preferably requiring little or no direct customer feedback during the iteration process itself.

Although the link budget planning means 460 is capable of making numerous types of determinations and providing numerous types of output related to link budget planning, the planned equipment list is a particular output that is advantageously employed according to embodiments of the present invention. Aspects relating to other types of calculations and outputs performed and produced by the link budget planning means 460 are described in applicant's co-pending U.S. Pat. application Ser. No. ______ which is incorporated herein by reference.

As mentioned previously, in step 408, the link budget planning means 460 produces an output, such as an equipment list, based on the network planning means output and link budget calculations from step 406. In step 409, the equipment list, which has preferably been produced following iteration through steps 407, is provided to a business modeling means 470. In step 410, the business modeling means calculates any number of business parameters based on the network configuration and specific equipment list. In a preferred embodiment of the present invention, this business parameter is a cost. The type of cost that may be calculated will be described later in more detail. The business parameter is either stored or displayed (or both). This stored or displayed business parameter comprises a useful, tangible result that may be used in order to support a network consultant's business proposal to a customer. Such business parameter may provide a customer with an understanding of the costs associated with each iteration of the model to determine if an agreeable cost parameter has been reached. In order to enable the provision of such a business parameter to a customer, the business parameter and possibly data associated therewith is stored in a memory or displayed on a display means, or both, as is well known in the art.

Based on this calculated business parameter, a network business report may be produced in optional step 411. This report comprises another useful, tangible result that may be used in order to support a network consultant's business proposal to a customer. Such a business proposal may include one or more business cases to initiate a build plan to extend an existing network, replace parts of an existing network, or add features and functionalities to current services being offered to the end-customer. The term network business report as used herein represents any report having to do with the real implementation of a network solution with respect to a business parameter and may advantageously include network equipment-related information, cost-related information, or both. The types of simple network business report that may be produced include, for example: a bill of materials; a listing of node configurations; and a raw data file and equipment list per node. In the case of a raw data file, the raw data itself represents a useful, concrete and tangible result that may be used as it is. This raw data file may be different from the data that is stored or displayed in association with the calculation of one or more business parameters. In an alternate embodiment, an advanced network business report, based on raw data produced from the cost calculations, may preferably be generated. The term advanced network business report as used herein represents any report that is based on data gathered from a simple network business report, as defined above, or from the data that is stored or displayed in association with the calculation of one or more business parameters, and may advantageously include network equipment-related information, cost-related information, or both. The generation of advanced network business reports will be discussed later in further detail.

FIG. 4B illustrates a flow diagram representing a method according to another embodiment of the present invention. This flow diagram attempts to illustrate, in a simpler fashion, the main steps in a method according to a particular embodiment of the present invention. In particular, flow diagram 490 in FIG. 4B illustrates steps to be followed in a method wherein the initial network configuration determination is not performed by the network consultant. Similarities will be easily seen between the steps in FIGS. 4A and 4B, and any alternatives described with respect to FIG. 4A are also applicable for the case of FIG. 4B. References to a “network consultant” below refer to apparatus that may be employed by a network consultant, for example such apparatus to achieve a fully computer-implemented method.

In step 491 in FIG. 4B, the network consultant collects relevant data. This data may include such data as customer identification data, network identification data, or any other data related to a particular customer situation. In step 492, a network configuration based on customer parameters is obtained. This network configuration is obtained from the customer or from a third party, depending on the source of the information regarding a network configuration based on customer parameters. Alternatively, the network consultant may perform the steps relating to the determination of an initial network configuration. In step 493, the network consultant performs link budget calculations based on the initial network configuration and customer parameters.

Steps 494 and 495 comprise preferred, yet optional, steps in this method according to an embodiment of the present invention. In step 494, it is determined whether desired network criteria are met by the network configuration that is proposed. If any of such desired network criteria are not met, the network consultant modifies the network configuration to satisfy network criteria and the method returns to step 493. As described above, the steps 493, 494, and 495 may be iteratively repeated until the desired network criteria are met. The point at which such iteration will be stopped may be the point at which a particular parameter reaches a user-defined threshold. This threshold may be preferably defined by the customer, or alternatively by the network consultant. For instance, where all the demand requirements are satisfied and the cost model appears favorable to the customer, iterations may be stopped. Any other type of threshold, for instance comprising a specified set of desired values or tolerances, is suitable, preferably requiring little or no direct customer feedback during the iteration process itself.

In step 496, an equipment list is generated based on the link budget calculations. In step 497, calculations are performed in order to determine, based on equipment list, at least one business parameter associated with the implementation of a proposed network configuration. Finally, in step 498, data associated with the one or more business parameter(s) is stored or displayed, thereby providing a useful, tangible result. Of course, an advanced network business report may preferably be produced following the storage/display of the business parameter(s), as described earlier.

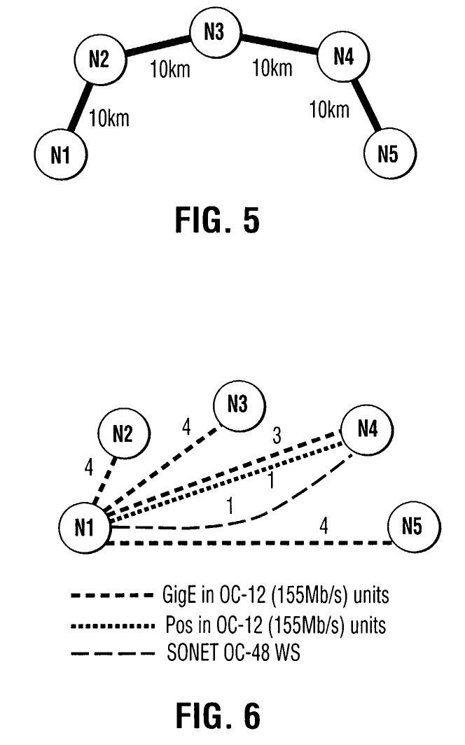

A specific example will now be illustrated. FIG. 5 illustrates a five-node linear network topology of a sample customer network. FIG. 6 illustrates network demand parameters that have been provided by a customer with respect to the network illustrated in FIG. 5. Note that three types of traffic are identified in the network demand parameters of FIG. 6: Gigabit Ethernet; Packet over SONET; and SONET OC-48 wavelength service. FIGS. 5 and 6 show the customer network topology and customer demand relating to a sample customer network. The scenario illustrated by this sample customer network is a simple case that can be relatively easily understood without the use of sophisticated tools.

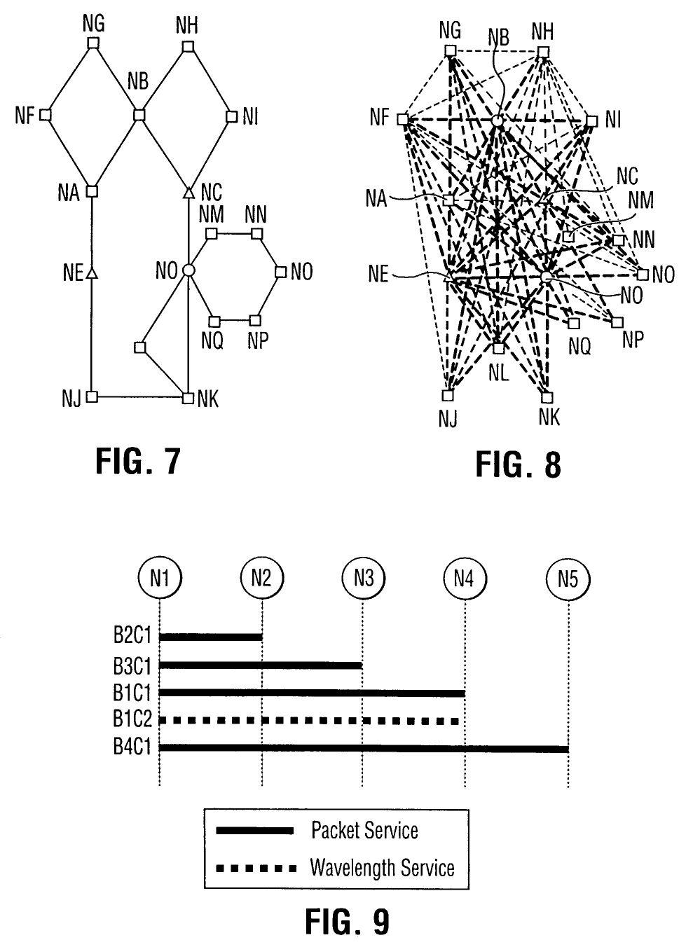

FIG. 7 illustrates a network topology of another sample customer network. FIG. 8 illustrates diagrammatically customer demand relating to the sample customer network of FIG. 7. This customer demand may be defined with respect to one or more traffic types, and may be defined with respect to any number of other parameters. FIGS. 7 and 8 show the customer network topology and customer demand relating to a more complicated sample customer network. This case demonstrates the need for a tool to assist in the design process because of the complexity of the customer network topology and customer demand. Such a tool has been described above with respect to embodiments of the present invention as illustrated in FIGS. 4A and 4B.

FIG. 9 illustrates a wavelength map of the customer demands shown in FIG. 6. The Gigabit Ethernet demands and POS demands in FIG. 6 are packet services. These packet services are satisfied by B2C1, B3C1, B1C1, B4C1 in FIG. 9, represented by solid lines. The SONET OC-48 wavelength service in FIG. 6 is satisfied by B1C2, represented by a dashed line. FIG. 9 shows an example of the waveband assignment chosen by a network planning means, for example VPI TranportMaker™, which serves as an input to the Link Budget Planning means as per step 407-2.

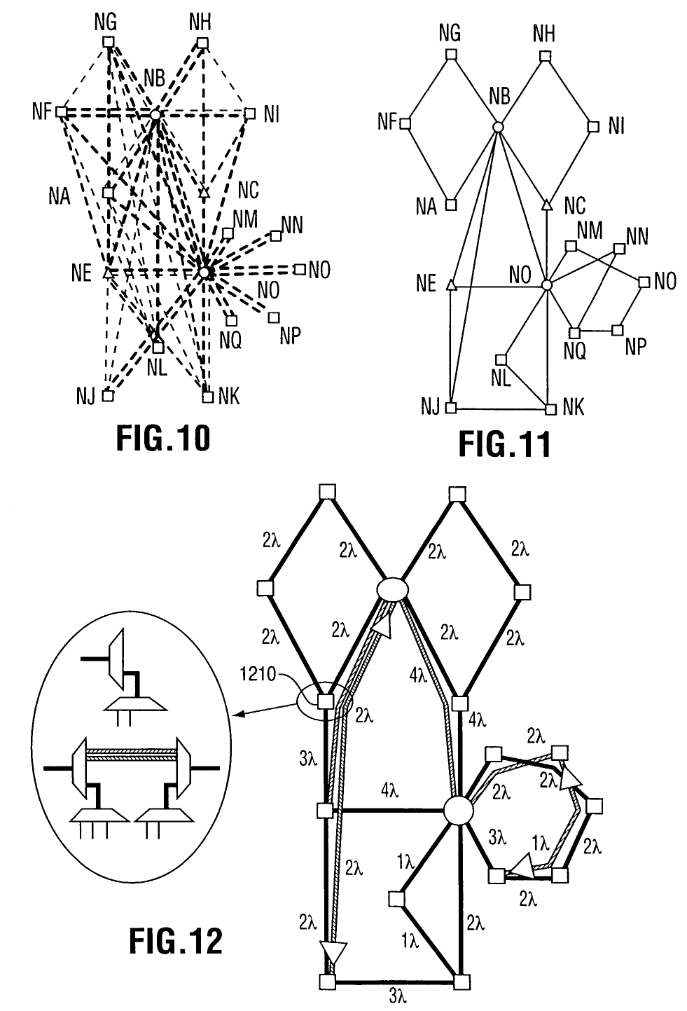

FIG. 10 illustrates the demands shown in FIG. 8 in terms of internal aggregated demands, taking into account any relevant routing issues. These internal aggregated demands with respect to the fiber topology are preferably used by the link planning means according to an embodiment of the present invention to perform necessary calculations. FIG. 11 illustrates the demands of FIG. 10 in terms of wavebands. The expression of demands in terms of wavebands is preferably achieved following bundling/grooming. This bundling/grooming may preferably be performed by the link planning means.

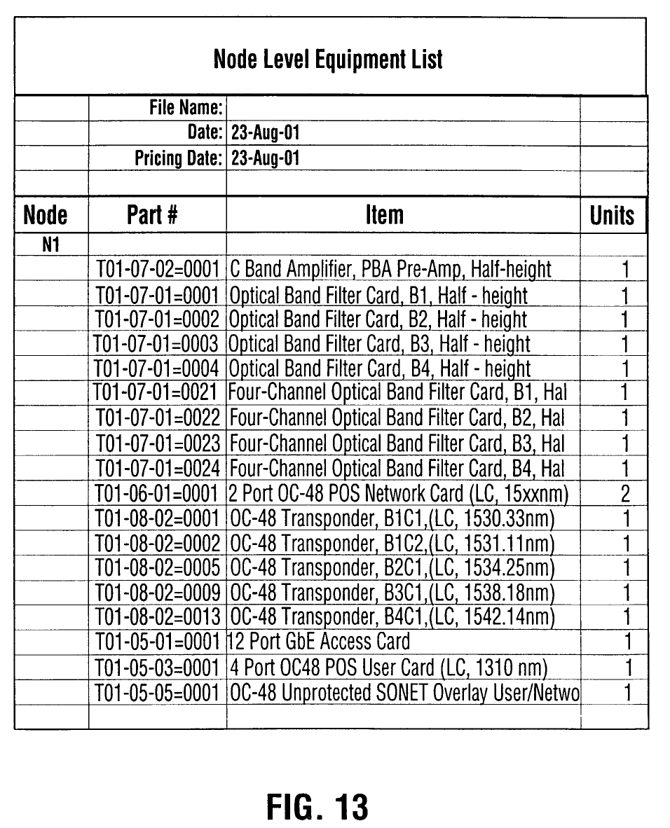

FIG. 12 illustrates an optical layer output relating to the network of FIG. 10. This figure illustrates the specific network equipment and module connections that have been determined to be necessary following the network planning/configuration and link planning calculations. FIG. 12 also illustrates, for a particular node 1210, a view of the specific filters and connections that may be used therein. FIG. 13 illustrates a sample equipment list that may be generated by the link planning means, which would subsequently be used for business parameter calculations by the business modeling means.

### Business Modeling

In accordance with the description above, embodiments of the present invention will enable a customer to properly understand business parameters such as the operational and capital costs associated with network modeling exercises. Modeling a customer network according to the generic network model described above allows a network consultant to analyze opportunities to increase untapped revenue streams, investigate areas of previously unrealized savings and bring to light areas of reduced operational and capital expenditures in a customer's network. Advantages related to a network consultant's solution might become quite evident when the network results are modeled and the business parameters related thereto are then compared to any competitive or existing solution.

Network scaling is feature that is advantageously provided according to an embodiment of the present invention. In employing the network scaling feature, it is possible to simulate costs and scrutinize potential network changes to investigate whether any excess pressure points may develop under certain circumstances. Often, in conventional approaches, a network consultant would only provide a customer with a present mode of operation (PMO) situation, and this may look very favorable. However, with conventional approaches, the network consultant typically isn't able to obtain modeling capability that considers the future mode of operation (FMO) to understand where additional costs and inefficiencies may arise. Embodiments of the present invention, through the integrated model described earlier, enable a network consultant to understand the cost to build the network and the cost to grow the network, and to pass on this understanding to the customer. By incorporating results obtained using the network scaling feature, the network consultant is able to provide optimal, efficient solutions that result in a customer's network being of low cost and having maximized network efficiency and effectiveness, having regard not only to current demand and topology, but also to potential network scaling. In implementing a build-out growth strategy employing the network scaling feature, excessive, escalating costs associated with conventional plans will preferably be avoided. In incorporating a consideration of network scaling, a linear growth curve that ensures increased margins with increased end-user demand is preferably achieved.

According to an embodiment of the present invention, there is also an ability to implement a series of ‘what if’ scenarios that will provide well-documented examples that a network consultant or a customer may include in business case and deployment strategies. These scenarios are preferably implemented based on the network scaling feature described above. It is thus possible to consider as many different scenarios and analyze costs and revenue opportunities in as many ways as desired, with the only limiting factor being the nature of the various customer parameters provided. In effect, embodiments of the present invention permit the formulation of accurate contingency plans to deal with problems or scenarios that may arise in the future. Such enhanced contingency planning may assist a network consultant employing embodiments of the present invention to enable a customer to maintain a competitive advantage over competitors, since such competitors may be attempting to formulate their contingency plans based on conventional non-integrated planning tools.

Business Parameter Calculation and Report Generation

Unlike many existing ‘cookie-cutter’ total cost of ownership (TCO) reports and other analytical tools, embodiments of the present invention may calculate a wide range of business parameters and generate a multitude of reports, each of which constitutes a concrete, useful and tangible result. In contrast to existing approaches, embodiments of the present invention consider areas of risk. There are a great number of risk elements that can affect a network's success. These elements may include: shifting customer patterns, increased competition, increased general market chum rates, economic forecast changes, sudden interest rate changes and the general fluctuation of the cost of money.

Embodiments of the present invention seek to minimize these risks by instituting ‘what-if’ analysis, as described above, as part of the risk assessment. This analysis is preferably performed on one or more particular business parameters, or network metrics. Because these business parameters are calculated quickly, a number of varied scenarios may be introduced, and the effect on revenues and operational and capital costs may be observed in real time

According to a preferred embodiment of the present invention, a report is produced based on a calculated business parameter. Some specific examples of advanced network business reports that are preferably produced according to an embodiment of the present invention include:

Cost/Benefit Analysis—In this exercise, an analysis is performed over a 4-year period in order to determine the changing risks as time goes by. Also, the overall risk is preferably categorized as operational, capital, internal and external. At this point, the risks and the benefits are compared in order to acquire a high level understanding of risk versus benefit. The more the cause of the risk can be isolated, the better it may be controlled.

Full Risk Analysis—In this exercise, network investment cash-out is measured against net network benefits (again over the same 4-year period) to determine a level of exposed risk. A fixed cost of capital rate and an adjustable rate of inflation are preferably factored in to the analysis. Typically, a network consultant may rely on a customer to provide such information as the fixed cost of capital.

Return On Invested Capital (ROIC)—One of the most important success ratings, this analysis may be performed in order to allow a customer to understand the specific payback period associated with implementing a network consultant's optimized network configuration.

In the end, embodiments of the present invention allow a network consultant to encompass into a business plan an educated understanding of the level of risk that may possibly be faced by a customer in pursuing a proposed solution. This provides an opportunity for a network consultant to demonstrate the strength of their proposed solution, particularly if it can show that a customer will realize a lower level of risk using the network consultant's solution than that to which the customer may be accustomed or may be anticipating.

Example Using ‘Cost to Build’ Business Parameter

A particular example of the calculation of a business parameter known as ‘cost to build’ will now be described. Cost to build is a key business parameter in which a customer may often be interested. The actual calculations involved in determining the cost to build are preferably performed at a business modeling means of an apparatus according to an embodiment of the present invention. This business modeling means is preferably provided as a software module powered by a computer's processor. The formulae used in these calculations are commonly known economic formulae that are all well known to one skilled in the art.

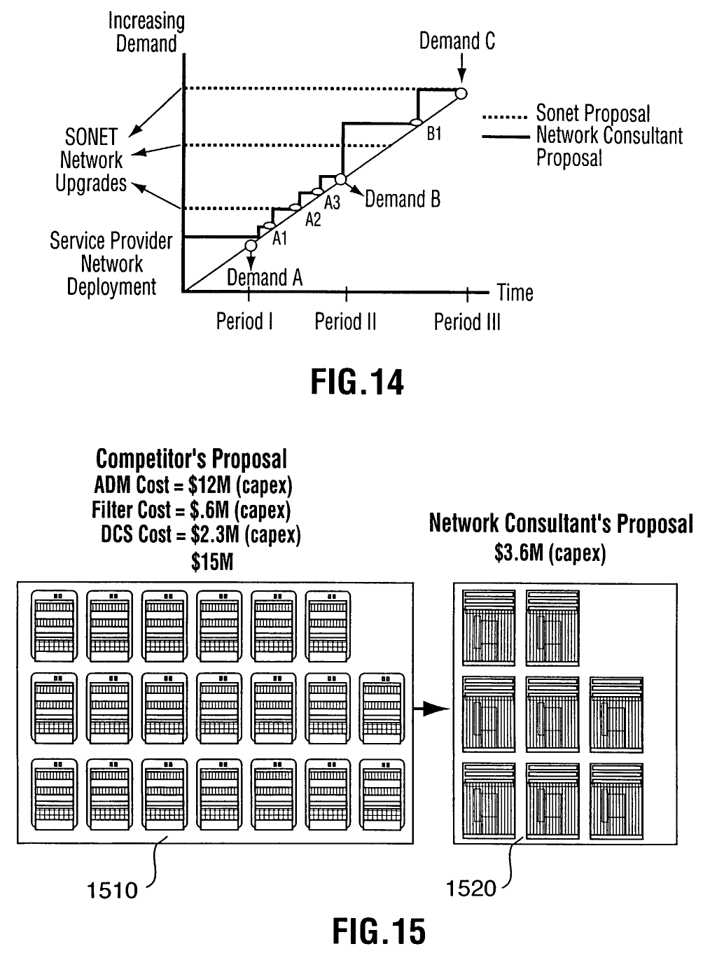

FIG. 14 illustrates a graphical depiction of a generic demand growth curve upon which a cost to build business parameter may be calculated. In this example, the cost to build is calculated at each of a plurality of demand points, which are identified as Demand A, Demand B and Demand C. These demand points provide a statistical basis from which changes and effects on network operational and capital expenditures based on increasing demand may be measured. Of course, many business parameters in addition to the cost to build may be simultaneously observed.

Reference characters A1, A2 and A3 indicate examples of increasing demand levels. For instance, in a case where 50 new end-users have signed on to a service provided by a customer, the demand is said to have grown from A to A1 etc. With a traditional SONET network, one would build and design for Demand A. Once the demand has exceeded level A, one would then build a network upgrade to handle up to a level of increased Demand B. However, there are inefficiencies in this methodology that become evident. For instance, when demand grows from Demand A to Demand A1 and one has to built out to be able to handle Demand B, the inefficiency is x1, where x1 is defined as follows: x1=demand B−demand A1. The cost associated with this inefficiency may be tremendous, both operationally and in a capital sense. With a network designed in accordance with embodiments of the present invention, it is possible to scale from Demand A to Demand A1 without producing the same quantity of inefficiencies. Such inefficiencies of the SONET network may be evidenced by modeling each of the two network scenarios, according to an embodiment of the present invention, and comparing the costs associated with the two platforms.

In fact, while demonstrating the cost and savings structures during the growth scenarios, an embodiment of the present invention advantageously enables a network consultant to compare its network proposal to one or more competing proposals. In the example of FIG. 14, the cost to build of a network consultant's network proposal (represented by solid lines) is compared to a competitor's NG-SONET proposal (represented by dashed lines) over the same demand growth period. The customer-specific network model based on the generic network model described earlier is employed to accurately compare the two networks.

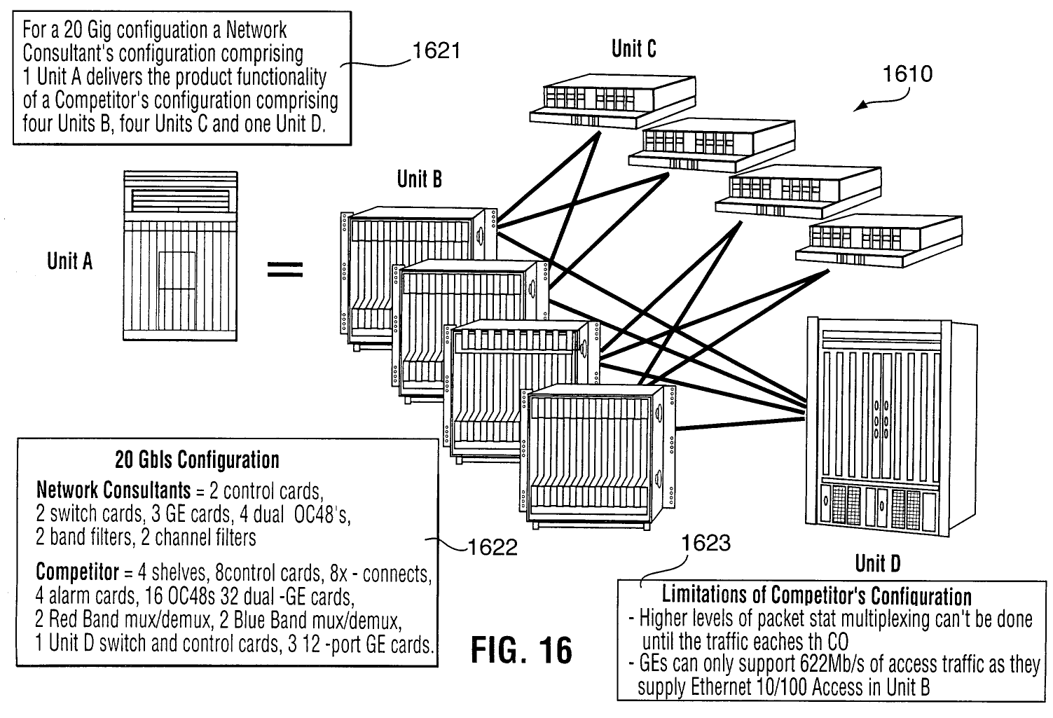

FIGS. 15 and 16 illustrate specific examples of advanced network business reports. FIG. 15 illustrates a first example of an advanced network business report showing the equipment needed at one site in a network and comparing the capital expenditures and operational expenditures of two possible solutions. In the example of FIG. 15, a hub node within the network model has been exposed and the requirements between solutions have been compared. In particular, FIG. 15 illustrates a comparison of the cost to build business parameter of a network consultant's proposal 1510, requiring $3.6M of capital expenditures, to a competitor's NG-SONET network proposal 1520, requiring a total of $15M of capital expenditures. FIG. 15 also illustrates a comparison of the floor space requirements of the two proposals, with the service provider's proposal 1510 clearly occupying less floor space, and consuming less power.

FIG. 16 illustrates a second example of an advanced network business report. In the example of FIG. 16, two types of equipment are compared at a node level. Using an advanced network business report as shown in FIG. 16, a network consultant is able to demonstrate the node-level cost savings that may be achieved by implementing the network consultant's network proposal. The exemplary advanced network business report in FIG. 16 comprises a graphical area 1610 and a plurality of text or information areas, although any combination of such types of areas could alternatively be used to convey advanced network business report information. In the particular example of FIG. 16, it is shown diagrammatically in the graphical area 1610 that one shelf of the node included in the network consultant's proposal is able to provide the same functionality as four shelves plus additional equipment in the competitor's proposal. A summary information area 1621 preferably provides a summary, textual or otherwise, of a comparison between a network consultant's proposal and one or more other proposals, preferably providing information regarding advantages of the network consultant's proposal. A detailed information area 1622 preferably provides a more detailed comparison of the networks being compared, as is illustrated in the textual information shown in FIG. 16. A limitation summary information area 1623 preferably provides an elaboration regarding limitations or drawbacks associated with a network configuration, such as a competitor's configuration, with which a network consultant's proposal is being compared.

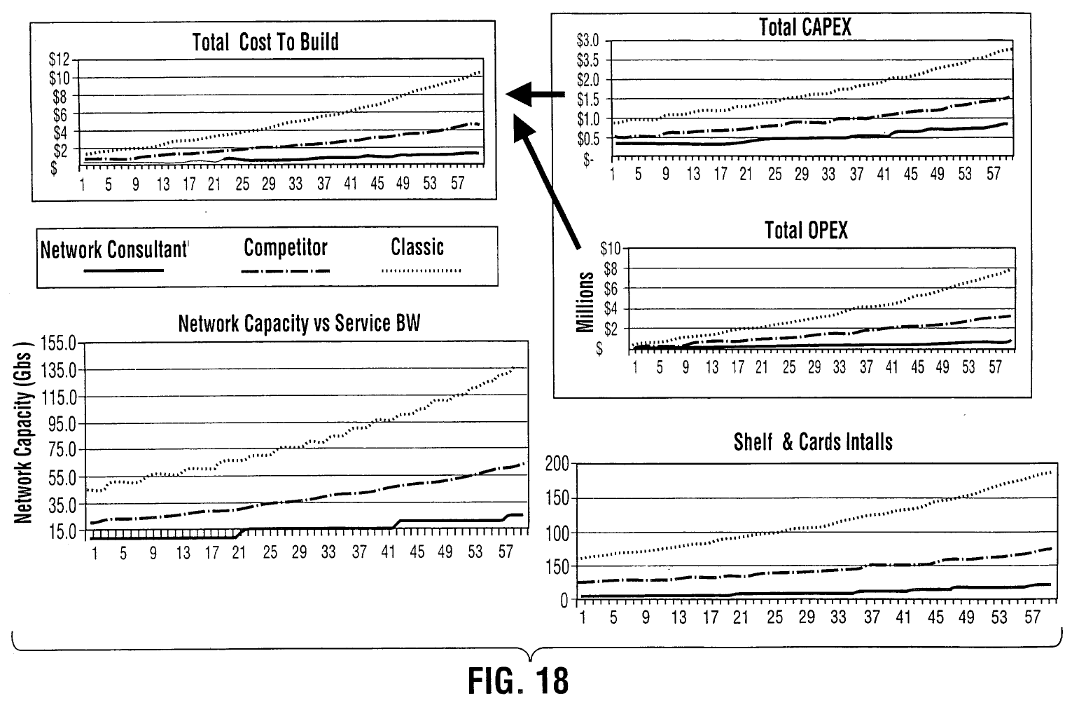

Although the cost to build business parameter, or any other business parameter, may be described in great detail, it is also important to be able to provide executive-level summary statements for business case applications. Therefore, according to an embodiment of the present invention, all of the detailed cost to build information may be preferably presented in an executive level summary. For example, a one-page summary advanced network business report of “cost to build” preferably breaks down the detailed information into short-term and long-term savings by operational costs and by capital costs. FIG. 18 illustrates an example of a cost to build executive-level summary statement network business report in accordance with an embodiment of the present invention. The particular example in FIG. 18 is illustrated in graph form. There is also an attempt to measure the intangible benefits along with the tangible savings, to provide wide breadth cost information.

Such one-page summary advanced network business reports are preferably provided for each business parameter that is calculated according to embodiments of the present invention. These summaries are ideal for the acceleration and execution of a customer's business plans and for inclusion into a business case, which may be presented by a network consultant to a customer or potential customer.

Examples of Business Parameters

Although an example comprising the cost to build business parameter was presented above, embodiments of the present invention provide for the calculation of numerous other business parameters, such as cost to own and cost to grow. For each of these business parameters, a detailed understanding of the anticipated demand forecasts and any other changes to a customer network infrastructure are required in order to properly model the changes and ensure that all developments and strategic decisions are captured in the customer network model. These parameters are all preferably provided by the customer, but may alternatively be provided by the network consultant, or by a third-party.

Table 2 below illustrates some of the other possible business parameters that may be calculated, and upon which advanced network business reports may be generated.

TABLE 2

| Metric | Description | Measures |
|---|---|---|
| ROA | Return On Assets | Calculated by determining |
| | (4 yr avg.) | the annual return on assets |
| | | for each of the 4 years and |
| | | then averaging the |
| | | resulting values. |
| ROI | Return On Investment | Trailing 12-month income |
| | (4 yr avg.) | (before taxes) divided by |
| | | the average long-term debt |
| | | and other long term |
| | | equities (listed as a %). |
| Capital | Capital Cost breakdown | Total capital cost |
| Expenditure | for build, own, grow | requirement |
| Operational | Operational cost | Total operational cost |
| Expenditure | breakdown for | requirement |
| | build, own, grow | |
| NPV | Net Present Value | Determines the |
| | (4 yr. Period) | opportunity and financial |
| | | cost of money |
| TCO | Total Cost of Operation | Industry accepted |
| | | measurement of telecom |
| | | costing. Slightly more in- |
| | | depth then Opex |
| Discounted Cash | Time value of money | Cash flow is discounted by |
| Flow | | calculating the present |
| | | value, which requires the |
| | | sum to be reduced by a |
| | | rate of interest equivalent |
| | | to the organizations |
| | | investment opportunity |
| | | rate. This discounting is |
| | | done for each year that it |
| | | takes to obtain or make the |
| | | payment. |

The actual calculations involved in determining any of these business parameters are preferably performed at a business modeling means of an apparatus according to an embodiment of the present invention. This business modeling means is preferably provided as a software module powered by a computer's processor. The formulae used in these calculations are commonly known economic formulae that are all well known to one skilled in the art. Embodiments of the present invention are easily adapted to the calculation of other similar known economic and business parameters.

Third Party Costing

In an embodiment of the present invention, there is an attempt to encapsulate as many degrees of operational costing as possible. The reason for this is to obtain the most comprehensive information to best represent the network models that are used. A business parameter known as third party costs is used to represent these many degrees of operational costing. Third party costs may be a critical factor to a customer in determining the expenses that will be involved in running a network. Some of the costs in this category may include: co-location costs (detailed power and space costing); provisioning costs (for greenfield and growth situations); and training costs (network engineering, operational, support). A greenfield network is a term usually describing an original first-generation deployment of a telecommunications network. A greenfield network, in contrast to a legacy network, is typically designed and built from scratch, with no need to accommodate legacy equipment or architecture.

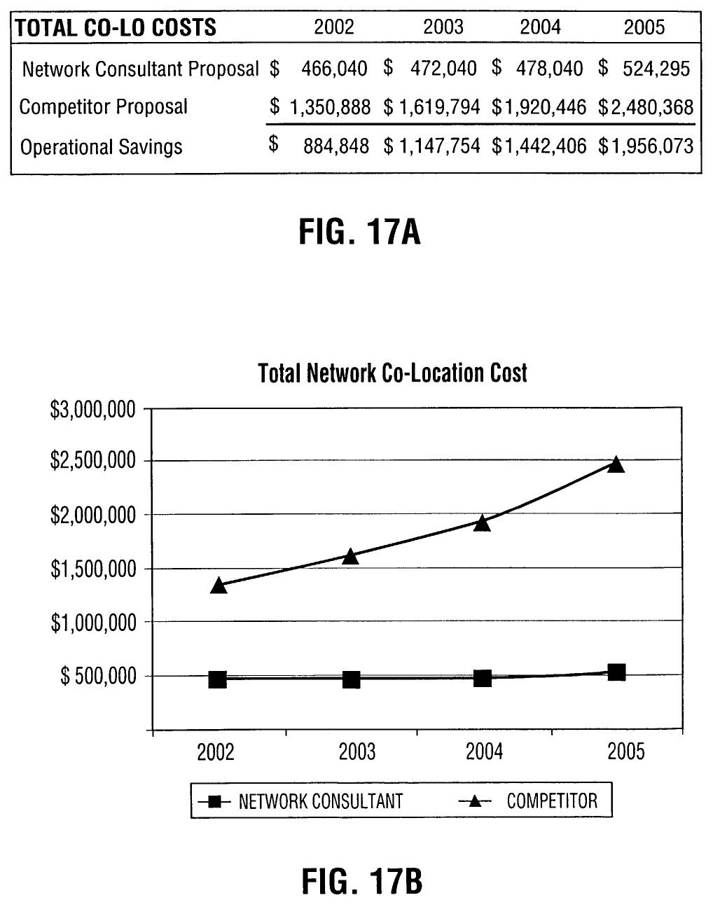

As an example of implementation, FIGS. 17A and 17B illustrate examples of advanced network business reports based on total network co-location cost for two networks. The actual co-location costs shown in FIG. 17A are calculated in accordance with the method described in relation to FIG. 14. In the report of FIG. 17A, a tangible tabular result is presented illustrating the operational savings achieved with the network consultant's solution over an existing solution or competitor's solution. In the report of FIG. 17B, a tangible graphical result is presented illustrating a comparison of the total network co-location cost of the network consultant's network and its competitor's network. These output reports are immediately useful to both the customer and network consultant in evaluating the strength of the network consultant's solution.

As another example of implementation, FIG. 18 illustrates an example of an advanced network business report based on total network co-location cost for three networks: a network consultant's proposal; a competitor's proposal, preferably based on a next generation network; and an existing conventional, or classic, proposal, preferably based on an existing configuration. FIG. 18 shows that an advanced network business report can comprise characterizations of one or more business parameters. In this particular example, graphs relating to the following business parameters are presented: total cost to build, consisting of total capital expenditures (capex) and operational expenditures (opex); shelf and card installs; and network capacity vs. service bandwidth. The report shown in FIG. 18 is a useful and tangible result presented in a format that allows a comparison of a plurality of network proposals with respect to a plurality of business parameters.

In accordance with another aspect of the present invention, there is provided the ability to include a customer in the network consultant's development process. This is particularly beneficial when the network consultant also provides and develops network equipment. An Early Access Partnership (EAP) will allow an network consultant's customers to interact with the network consultant's development team (hardware, software, physical design, network verification product integrity, etc.), thereby influencing the direction of releases and at the same time having exclusive access to internal equipment provider lab trials. Such a collaborative development process will preferably result in: accurate consideration of evolving customer requirements; improved designs having the benefit of immediate customer feedback; better handling of potential ambiguities in the development process; more accurate tracking of progress; early risk reduction; and early identification of issues. Such collaboration may be achieved via web-enabled interactive sessions, or via traditional meetings, or any combination of approaches along that spectrum.

In summary, a major reason for developing a method and apparatus according to embodiments of the present invention is to allow a network consultant to integrate business modeling with network planning so as to quickly and efficiently generate accurate business models based on proposed network configurations, thereby providing a customer with proof of the strength of the network consultant's solution that maximizes the customer's return on investment.

The benefits, savings, reduction in operational and capital costs and all the other elements of network savings that are identified according to embodiments of the present invention will preferably be summarized in qualitative and quantitative fashion for a customer's senior management through the generation of business parameters and reports based thereupon. An Executive Summary will preferably be provided for all areas of analysis. For example, an Executive Summary may be presented for Network Architecture costs, cost to build, Risk Analysis, Cost/Benefit Analysis and many other areas. Additionally, a detailed analysis and set of recommendations may be provided to assist the customer in understanding all the advantages that the network consultant's solution can bring.

Embodiments of any of the aspects of the present invention can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product). For example, in a method according to an embodiment of the present invention, various steps may be performed at each of a bandwidth modeling means, network planning means, link budget planning means, or business modeling means. These steps may be implemented via software that resides on a computer readable memory located at each of said bandwidth modeling means, network planning means, link budget planning means, or business modeling means.

Although various exemplary embodiments of the invention have been disclosed, it should be apparent to those skilled in the art that various changes and modifications can be made which will achieve some of the advantages of the invention without departing from the true scope of the invention.

What is claimed is:

1. A computer-implemented method for performing integrated optical network planning and business modeling, comprising the steps of:
a) obtaining a network configuration based on customer parameters;
b) performing link budget calculations based on said network configuration and customer parameters;
c) generating an equipment list based on said link budget calculations;
d) calculating, based on said equipment list, at least one business parameter associated with implementation of said network configuration; and
e) storing or displaying data associated with such business parameter.

2. A method according to claim 1 further comprising the step of:
producing a report based on said at least one business parameter.

3. A method according to claim 1 wherein said customer parameters comprise standardized customer demand and customer topology.

4. A method according to claim 1 wherein said standardized customer demand comprises aggregate customer demand by node and line side port count by node.

5. A method according to claim 1 wherein step a) comprises determining said network configuration based on said customer parameters.

6. A method according to claim 5 wherein said customer parameters comprise standardized customer demand and customer topology.

7. A method according to claim 6 further comprising, before step a), the steps of:
receiving customer demand per node port from the customer; and
converting said received customer demand into said standardized customer demand.

8. A method according to claim 6 wherein said standardized customer demand comprises aggregate customer demand by node and line side port count by node.

9. A method according to claim 3 wherein said customer topology comprises an identification of nodes and physical links in the topology.

10. A method according to claim 5 wherein step a) further comprises the step of determining node and layer 1 logical link topology for said network configuration.

11. A method according to claim 10 wherein step b) further comprises the step of performing calculations based on said node and layer 1 logical link topology.

12. A method according to claim 1 further comprising, between step b) and step c), the steps of:
producing a revised customer topology based on said network topology and said link budget calculations; and
repeating steps a) and b), wherein said customer parameters comprise customer demand and said revised customer topology.

13. A method according to claim 1 wherein one said business parameter comprises a cost.

14. A method according to claim 13 wherein said cost is selected from the group comprising: capital cost, operational cost, cost to own, cost to grow, cost to build, net present value, total cost of operation, and time value of money.

15. A method according to claim 2 wherein said report is a simple report selected from the group comprising: a bill of materials, a listing of node configurations, and a raw data file.

16. A method according to claim 2 wherein said step of producing a report comprises generating an advanced network business report based on said stored or displayed data.

17. A method according to claim 16 wherein said advanced network business report is selected from the group comprising: cost/benefit analysis, full risk analysis, return on assets, return on invested capital, capital expenditure, operational expenditure, net present value, total cost of operation, time value of money, total cost of ownership, cost to build, cost to own, cost to grow.

18. A method according to claim 1 wherein said optical network comprises at least one electronic network component.

19. A system for integrated optical network planning and business modeling, comprising:
network planning means for obtaining a network configuration based on customer parameters;
link budget planning means for performing link budget calculations based on said network configuration and customer parameters, and for generating an equipment list based on said link budget calculations; and
business modeling means for calculating a business parameter associated with implementation of said network configuration based on said equipment list, and for storing or displaying data associated with said business parameter.

20. A computerized system for integrated optical network planning and business modeling, comprising:
network planning means for obtaining a network configuration based on customer parameters;
link budget planning means for performing link budget calculations based on said network configuration and customer parameters, and for generating an equipment list based on said link budget calculations; and
business modeling means for calculating a business parameter associated with implementation of said network configuration based on said equipment list, and for storing or displaying data associated with said business parameter.

21. A system according to claim 20 wherein said business modeling means further comprises means for producing a report based on said at least one business parameter.

22. A system according to claim 20 wherein said customer parameters comprise standardized customer demand and customer topology.

23. A system according to claim 20 wherein said standardized customer demand comprises aggregate customer demand by node and line side port count by node.

24. A system according to claim 20 wherein said network planning means further comprises means for determining said network configuration based on said customer parameters.

25. A system according to claim 24 wherein said customer parameters comprise standardized customer demand and customer topology.

26. A system according to claim 25 further comprising bandwidth modeling means for receiving customer demand per node port from the customer, and for converting said received customer demand into said standardized customer demand.

27. A system according to claim 25 wherein said standardized customer demand comprises aggregate customer demand by node and line side port count by node.

28. A system according to claim 22 wherein said customer topology comprises an identification of nodes and physical links in the topology.

29. A system according to claim 20 wherein said network configuration upon which said link budget calculations are based comprises node and layer 1 logical link topology.

30. A system according to claim 20 wherein said link budget planning means comprises:
means for producing a revised customer topology based on said network topology and said link budget calculations; and
means for transmitting said revised customer topology to said network planning means.

31. A system according to claim 20 wherein said business parameter comprises a cost.

32. A system according to claim 31 wherein said cost is selected from the group comprising: capital cost, operational cost, cost to own, cost to grow, cost to build, net present value, total cost of operation, and time value of money.

33. A system according to claim 21 wherein said report is a simple report selected from the group comprising: a bill of materials, a listing of node configurations, and a raw data file.

34. A system according to claim 20 wherein said business modeling means comprises advanced report generating means for generating an advanced network business report based on said stored or displayed data.

35. A system according to claim 34 wherein said advanced network business report is selected from the group comprising: cost/benefit analysis, full risk analysis, return on assets, return on invested capital, capital expenditure, operational expenditure, net present value, total cost of operation, time value of money, total cost of ownership, cost to build, cost to own, cost to grow.

36. A system according to claim 21 wherein said optical network comprises at least one electronic network component.

37. A computer program product comprising a computer-readable memory storing statements and instructions for use in the execution in a computer of the method of claim 1.

38. A computer data signal embodied in a carrier wave and representing sequences of instructions which, when executed by a processor, cause the processor to calculate network costs in an automated manner by performing the steps of the method of claim 1.

39. A link budget planning apparatus suitable for use in a system described in claim 21.
